(19) United States
(12) Patent Application Publication
(10) Pub. No.: US 2024/0372419 A1
(43) Pub. Date: Nov. 7, 2024

(54) LOW-SPEED ELECTRIC GENERATOR

(71) Applicant: Askar Manashevich SADYKOV, Talgar (KZ)

(72) Inventors: Askar Manashevich SADYKOV, Talgar (KZ); Seriktes Tolembaevich TOKKULOV, Talgar (KZ)

(21) Appl. No.: 18/291,619

(22) PCT Filed: Aug. 16, 2022
(86) PCT No.: PCT/KZ2022/000011

§ 371 Date: Jan. 24, 2024

(30) Foreign Application Priority Data
Aug. 20, 2021 (KZ) 2021/0506.1

(51) Int. Cl. H02K 1/16; H02K 3/12

(52) U.S. Cl. CPC H02K 1/16; H02K 3/12

(57) ABSTRACT

The invention relates to electric machines. The claimed low-speed electric generator comprises a fixed magnetic core (stator) (E), a movable toothed magnetic core (rotor) (C), a magnet and windings, and is characterized in that the fixed magnetic core consists of a base element (B) assembled in the form of a magnet and, arranged on the magnetic core, one or two generating windings (D), the ends (A) of the magnetic core inside the generating windings are split into teeth at the point of magnetic interaction between the stator and the toothed rotor, the pitch of the teeth of the rotor and of the ends of the wound magnetic core of the stator is the same, and the area of the projecting toothed ends of the wound magnetic core is greater than or equal to the area of the magnetic core inside the windings.

### TECHNICAL FIELD

The invention relates to electric machines.

### BACKGROUND OF THE INVENTION

WO 2021025547 A1 discloses a Bayaliev universal generator-motor consisting of a stationary magnetic core (stator) comprising at least one base element in the form of a magnet with generating windings arranged on two sides of the magnet in a way that provides opposite magnetic flux transition in the windings during the movement of a movable magnetic core (rotor).

The above technical solution is the closest to the proposed invention by the majority of its features and its technical essence and can be considered as a prototype.

### SUMMARY OF THE INVENTION

It is an objective of the claimed invention to reduce a required angular speed of rotation of a rotor or, in the case of a linear generator, to reduce a linear displacement of a moving part of a magnetic core and to increase the rate of change of a magnetic flux, which leads to an increase in capacity in a generating mode, as well as to reduce the overall dimensions with a corresponding reduction in material intensity and to reduce energy costs for the forced rotation of the rotor in the generating mode.

The technical result achieved by implementing the objective is that parasitic resistances are reduced, the material intensity is reduced, affordability and manufacturability are achieved, and the capacity in the generating mode is increased.

The objective is implemented by the fact that a Sadykov low-speed electric generator comprises a toothed separation at the point of closing/opening of a magnetic core between a rotor and a stator, which leads to a multiple increase of the rate of change of the magnetic flux in the magnetic core of coils.

The objective is implemented by the fact that this principle works with all existing types of magnetic cores, both laminar and monolithic.

The objective is implemented by the fact that the separated magnetic core can be used in both linear and rotary types of generators.

A comparative analysis of the main features of the proposed solution and the prototype proves that it meets the requirement of “novelty”.

In this case, the distinguishing features of the claims solve the following functional tasks.

The feature “ . . . a stationary magnetic core (stator), a movable toothed magnetic core (rotor), a magnet and windings, characterized in that the stationary magnetic core comprises a base element assembled as a magnet and one or two generating windings arranged on the magnetic core, ends of the magnetic core in the generating windings has a toothed separation at a point of magnetic interaction between the stator and the toothed rotor, a pitch of teeth of the rotor and of the ends of the magnetic core with coils of the stator is the same . . . ”-reduces the required angular speed of the rotor in multiples of the number of teeth on the ends of the coils and, accordingly, allows one to reduce the size of the rotor.

The feature “ . . . an area of protruding toothed ends of the magnetic core of the coils is greater than or equal to an area of the magnetic core inside the coils . . . ”-maintains the same magnetic flux for different cross-sections of the magnetic core.

The feature “ . . . the base element assembled as the magnet has a continuous non-toothed end that closes the magnetic flux between the toothed rotor and the stator, providing a constant interaction area equal to or greater than the area of the protruding toothed ends of each of the coils . . . ”-maintains the same magnetic flux for different cross-sections of the magnetic core.

The feature “ . . . the movable toothed rotor is configured to enter into magnetic interaction with a plurality of base elements assembled as the magnet and the coils arranged on the magnetic core . . . ”-allows the generation of a multiphase electric current.

### BRIEF DESCRIPTION OF DRAWINGS

FIG. 1 shows a schematic diagram of a Sadykov linear low-speed generator.

FIG. 2 shows a schematic diagram of a Sadykov rotary low-speed generator.

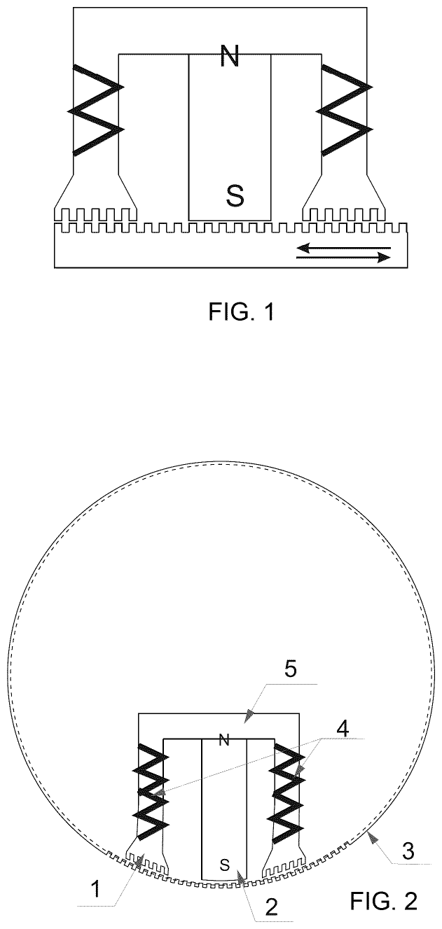

A—toothed end of a magnetic core of a coil
B—base element assembled as a magnet
C—movable toothed magnetic core (rotor)
D—generating coils
E—stator

### DETAILED DESCRIPTION OF THE INVENTION

WO 2021025547 A1 discloses the Bayaliev universal generator-motor, which confirms the possibility of generation of electric current by a moving magnetic core (rotor). The main disadvantage of this solution is the mandatory angular or linear displacement of a closing magnetic core to the width of the magnetic core, which increases a required angular or linear displacement of a toothed rotor/rod.

The claimed design of a Sadykov low-speed electric generator allows one to reduce the overall dimensions of the generator, reduce required angular and linear displacement speeds of the rotor or rod, which is extremely necessary for the state-of-the-art alternative energy sources.

1. A Sadykov low-speed electric generator comprising:
a stationary magnetic core, being a stator;
a movable toothed magnetic core, being a rotor;
a magnet; and
windings;
characterized in that
the stationary magnetic core comprises a base element assembled as a magnet and one or two generating windings arranged on the magnetic core;
ends of the magnetic core in the generating windings has a toothed separation at a point of magnetic interaction between the stator and the toothed rotor;
a pitch of teeth of the rotor and of the ends of the magnetic core with coils of the stator is the same; and
an area of projecting toothed ends of the magnetic core of the coils is greater than or equal to an area of the magnetic core inside the coils.

2. The Sadykov low-speed electric generator of claim 1, wherein the base element assembled as the magnet has a continuous non-toothed end that closes a magnetic flux between the toothed rotor and the stator, providing a constant interaction area equal to or greater than the area of the protruding toothed ends of each of the coils.

3. The Sadykov low-speed electric generator of claim 1, wherein the movable toothed rotor is configured to enter into magnetic interaction with a plurality of base elements assembled in as the magnet and the coils arranged on said magnetic core.
